(19) United States
(12) Patent Application Publication
(10) Pub. No.: US 2015/0315422 A1
(43) Pub. Date: Nov. 5, 2015

(54) Easily tearable adhesive tape

(71) Applicants: Peter Starzomski, Park Ridge, IL (US); Marek Starzomski, Kielce (PL)

(72) Inventors: Peter Starzomski, Park Ridge, IL (US); Marek Starzomski, Kielce (PL)

(21) Appl. No.: 14/120,175

(22) Filed: May 2, 2014

(51) Int. Cl. C09J 7/02

(52) U.S. Cl. CPC C09J 7/0296; C09J 2423/006

(57) ABSTRACT

A self-adhesive polyolefin tape is disclosed having a base film upon which is disposed an adhesive layer. The base film is a three layer structure: two outer layers surrounding an inner layer. The outer layers contain linear polyolefins having a crystallinity of 40%-100% and comprise at least 60% of ethylene monomer repeat units. The inner layer comprises linear polyolefins having a crystallinity of 40-100% and comprising at least 60% ethylene monomer repeat units and copolymers derived from cyclic olefin monomers of low or no crystallinity.

### BACKGROUND

Self adhesive tapes of current manufacture are prepared from polyolefins such as high and low density polyethylenes, linear low density polyethylenes, polypropylenes, polyethylene terephthalates, and polystyrenes. Typically, such polymers are used to fabricate the bases or base layers of such tapes in both modified and un-modified forms. And can be reinforced by mineral fillers and/or natural or synthetic fibers such as glass, polyester, polyamide, or carbon fibers. Such tapes have good tear resistance and acceptable running length elongation.

Fiber reinforced self-adhesive tapes of this type (fiber reinforced polymer base) have use limitations resulting from their tearability in the direction transverse to the running length.

### SUMMARY

This disclosure is directed to a self-adhesive tape characterized by properties of tear strength (TS) and elongation at break (EB, axial direction).

The tape of this disclosure exhibits tearability in the direction transverse to the axial direction (“running length”) which is facile and requires no cutting tools to effect a transverse tear. The tear edges of the tape disclosed herein does not leave a jagged or wavy tear edge. Instead, its tear edges show a uniform surface. The properties of this tape affording its performance characteristics derive from the novel structure and materials of its manufacture.

In one embodiment, the tape comprises a base and an adhesive layer with the base containing a three layer structure. The tape has an inner layer, and two outer layers.

In another embodiment of the disclosure, the tape comprises an inner layer, two outer layers and adhesive layer on each of the outer layers of the tape.

In another embodiment of the disclosure, the tape has a colorant in at least one of the layers.

In another embodiment of the disclosure, one of the outer layers of the tape has a thin easy to tear paper layer attached.

In another embodiment of the disclosure, the thin layer of paper can be written upon.

In another embodiment of the disclosure, at least one additional layer is positioned on top of at least one of the outer layers.

In one embodiment, outer layers (A, C) comprise linear polyolefins having a crystallinity ranging from 40% to 100%.

In another embodiment, the linear polyolefin of the outer layers comprise at least 60% of ethylene (monomer) repeat units. The modulus of elasticity for the outer layers is lower than 350 MPa.

In yet another embodiment, the inner layer (B) comprises linear polyolefins having a crystallinity ranging from 40% to 100% which has at least 60% ethylene (monomer) repeat units and polymers or copolymers derived from cyclic olefins which cyclic olefin derived polymers or copolymers are amorphous or of low crystallinity.

Another alternative embodiment has the polymer compositions of the inner layer comprising C2-C10 linear olefins and C5-C16 cyclic olefin monomers.

### BRIEF DESCRIPTION OF THE FIGURES

The accompanying drawings, which are incorporated herein and form a part of the specification, illustrate one or more embodiments of the present disclosure and, together with the description, further serve to explain the principles of the disclosure and to enable a person skilled in the pertinent art to make and use the disclosure.

FIG. 1 discloses a side schematic view of the first embodiment of the tape;

FIG. 2 discloses a microscopic image of the first embodiment of the tape;

FIG. 3 discloses a side schematic view of the first embodiment of the tape with adhesive:

FIG. 4 discloses a side schematic view of another embodiment of the tape with adhesive on both outer layers;

FIGS. 5A and 5B is a direct view showing the edge structure of the transverse tear in the axial direction for the single layer tape; and

FIGS. 5C and 5D is a direct view showing the edge structure of the transverse tear (to the axial direction);

### DETAILED DESCRIPTION OF THE DISCLOSURE

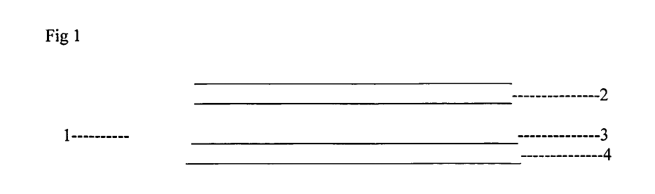

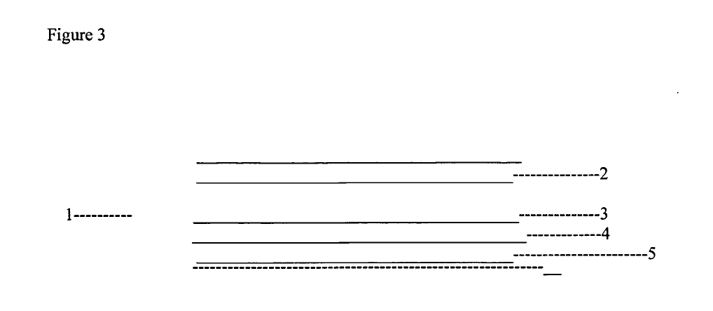

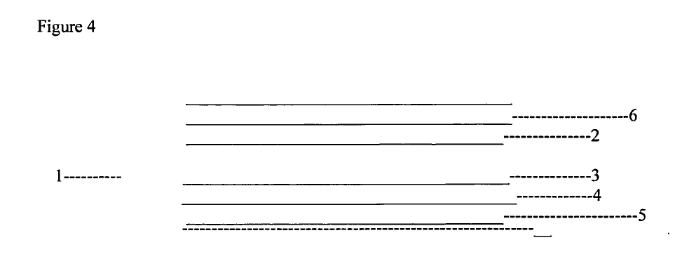

Referring in part to FIGS. 1-4, the self-adhesive tape has layer(ed) structures comprising polyolefins and an adhesive layer. The polyolefin base film 1 has at least three polyolefin layers 2,3, and 4. The top layer 2 is contains linear olefins. In one embodiment, the linear polyolefins are with crystallinity in the range from 40% to 100%. In another embodiment, the polyolefins with crystallinity are defined as containing at 60% ethylene repeat units. In another embodiment this layer has the modulus of elasticity lower than 350 MPa.

The second or middle layer 3 contains both linear polyolefins and cyclic olefins. In one embodiment, the layer contains linear polyolefins with crystallinity in the range of 40-100%. Additionally in another embodiment, the polyolefins with crystallinity in the range of 40%-100% contain at least 60% ethylene repeat units. The layer, as mentioned, also contains cyclic olefins or cyclic olefin copolymers of low crystallinity.

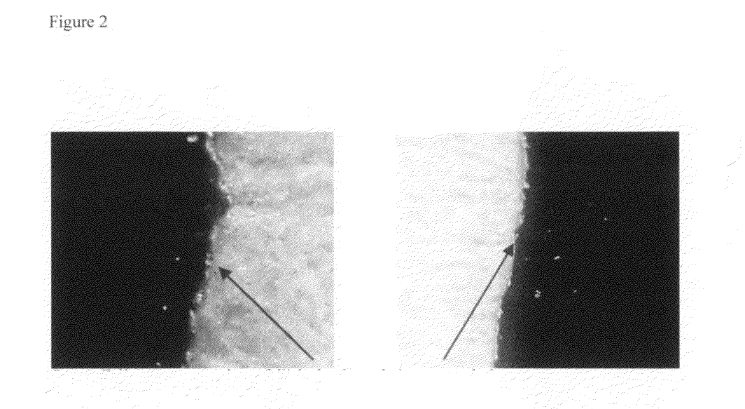

The second outside layer 4 can be identical to the first outside layer or there can be differences in the percentage rain of the crystallinity of the polyolefins and the amount of ethyelene repeat units. A microscopic image of the tape is shown in FIG. 2.

In one embodiment, one of the outer layers is coated with an adhesive 5. In another embodiment bother of the outer layers 2,4, are coated with an adhesive layer 5,6. Additionally, in another embodiment, layers 2,3,4, contain colorants or other additives. In another embodiment, one or both of the adhesives have positioned on their outside an easily removable paper layer 7,8. In yet another embodiment, a paper layer 9 resides on one of the outside layers 2

In another embodiment, copolymers based on C₂-C₁₀ olefins and C₅-C₁₆ cyclic monomers, containing from 20% to 98% by weight of olefins and from 20% to 80% by weight of cyclic monomers are used, it being the fact that preferably olefins have the form of ethylene and cyclopenten, cyclohexene, dicyclopentadiene, tetracyclododecane, or methyl tetracyclododecene are used as cyclic repeat unit.

In one embodiment, content of linear polyolefins and cycloolefins in layer 2 is in the range of 105 to 90% by weight.

In another embodiment, the weight ratio of linear polyolefin to cycloolefins in layer 2 ranges from 3:1 to 5: 1. In another embodiment, the weight ratio of the linear polyolefin to cycloolefins in layer 2 is 4:1. Additionally, in another embodiment, the two outside layers have the modulus of elasticity lower than 350 MPa, and the middle layer has a modulus of elasticity lower than 1200 MPa.

This self-adhesive polyolefin tape is characterized by decidedly better mechanica parameters, such as tensile strength at break at an acceptable value of EP (relative elongation at break) in comparison to tapes that are currently manufactured with a polymer base film. Additionally, the tape is characterized by a low tearability resistance in the transverse direction. The tape does not require the use of cutting tools, and tape edges after it is torn in the direction transverse to the axial direction have substantially uniform surfaces.

Using physical parameters described above and below, tearing energy is brought to a minimum to allow for production of tape characterized by a low tearability resistance in the direction transverse to the axial direction, and the resulting crack should form a straight line in the predefined direction, starting at tear initiation and move to the predefined direction, i.e., transversely to the axial direction.

The tape of the disclosure and its variants are manufactured by methods well known to those skilled in the art which include hot melt, solvent borne, and waterborne processes.

Mechanical properties of the tapes of this disclosure were tested by the PN-ISO 37; 1998 standard using the ZWICK tensile tester model 1435. For the purpose of comparison, the mechanical properties a a self-adhesive tape comprising a base made from a single layer of low density polyethylene was used. The thickness of the polymer base and weight of the adhesive layer of the subject three layer tape and reference single layer tape were identical.

The results of these tests are shown in the following table:

TABLE ONE
Tensile Strength and Elongation at Break for Self-Adhesive Tape

| | Tensile Strength | Elongation at |
|---|---|---|
| Tape | (TS in MPa) | Break (EB %) |
| Single Layer | 24.2 | 197.7 |
| Three Layer | 28.5 | 29.2 |

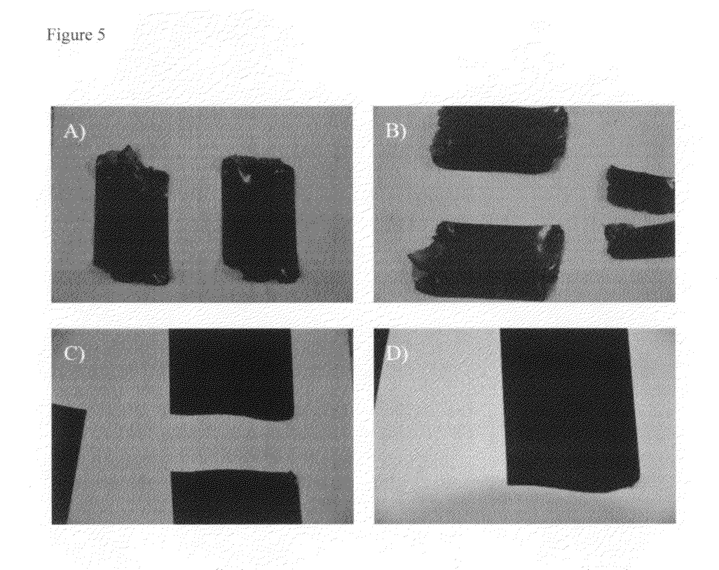

FIGS. 5A and 5B show the edge structure of the transverse tear (to the axial direction) for the single layer tape (reference). FIGS. 5C and 5D show the edge structure of the transverse tear (to the axial direction) for the three layer tape of the invention. The single layer tape clearly evidences a jagged or frayed tear edge while the tear edge of the three layer tape of the invention evidences a smooth tear edge.

Self-adhesive tapes may be manufactured by processes including hotmelt, processes solvent and/or waterborne film casting processes, and co-extrusion processes. The self-adhesive tapes of this disclosure are best prepared by film co-extrusion. For the manufacture of these tapes, three single-screw extruders 30 decimeters in length. Extruders one and three plasticize and extrude the linear polyolefin of outer layers. Extrude two, plasticizes and extrudes the cyclic polyolefin of the inner layer. Temperatures for all three extruders were as follows: Feed zone: 135-155° C.; Compression Zone: 160-190° C.; Metering Zone: 150-180° C.; Head: 145-175° C.

The thin wall tube formed with the head is cooled down and oriented along two axes at the same time. Skilled practitioners of polymer film extrusion will recognize that at the time of extrusion of plasticized plastic from the head annulus (nose), stream orientation of structural units of linear polyolefin depends upon the product of the longitudinal speed gradient and the relaxation time and that this product is proportional to viscosity of the co-extrudates and conditioned by solidification characteristics.

The scope of the self-adhesive tape of this disclosure is detailed in the following embodiments. For clarity, it should be noted that low density polyethylene (LDPE) is defined as the polymer obtained by addition polymerization of ethylene having a density of 0.910-0.930 g/cc with about 2% of carbons being branched. Linear low density polyethylene (LLDPE) has the same density but with fewer than 2% of the carbons being branched. High density polyethylene (HDPE) is the polymer obtained by addition polymerization of ethylene having a density of 0.930-0.970 g/cc. High density polyethylene has less branching, generally, that that of low density polyethylene but can have an even higher reduction in branching (LHDPE) if prepared over Ziegler-Natta type catalysts such as titanocene-triakylaluminum organometallic compounds well known to polymer chemists to provide polyolefins having a high degree of linearity from olefin feedstocks.

### EMBODIMENT ONE

Outer layers (A, C,) both contain linear low density polyethylene; 40% crystallinity. The thickness of the combined outer layers is 50% of the total thickness of the base film. Inner layer (B) contains 90% linear low density polyethylene, 40% crystallinity, and 10% cyclic olefin copolymers comprising C2-C10 linear polyolefins and C5-C16 cyclic olefins from the group: cyclopentene, cyclohexene, cycloheptene, dicyclopentadiene, tetracyclododecene, and methyl-tetracyclododecene. The thickness of this layer (B) is 50% of the total base film thickness. An adhesive layer was applied to the base film layer to afford a self-adhesive tape having tensile strength at break of 28.5 MPa and an elongation at break of 29.2%

### EMBODIMENT TWO

Outer layers (A, C,) both contain linear low density polyethylene; 40% crystallinity. The thickness of the combined outer layers is 50% of the total thickness of the base film Inner layer (B) contains of 50% linear low density polyethylene and 50% cyclic olefin copolymers derived from C2-C10 linear olefin monomers and C5-C16 cyclic olefin monomers from the group: cyclopentene, cyclohexene, cycloheptene, dicyclopentadiene, tetracyclododecene, and methyl-tetracyclododecene. The thickness of this layer (B) is 50% of the total base film thickness. An adhesive layer was applied to this base film to afford a self-adhesive tape having a tensile strength at break of 26.5 MPa and an elongation at break of 25.2%

### EMBODIMENT THREE

Outer layers (A, C,) both contain linear low density polyethylene; 40% crystallinity. The thickness of the combined outer layers is 50% of the total thickness of the base film Inner layer (B) contains 20% linear low density polyethylene and 80% cyclic olefin copolymers derived from C2-C10 linear olefin monomers and C5-C16 cyclic olefin monomers from the group: cyclopentene, cyclohexene, cycloheptene, dicyclopentadiene, tetracyclododecene, and methyl-tetracyclododecene. The thickness of this layer (B) is 50% of the total base film thickness. An adhesive layer was applied to this base film to afford a self-adhesive tape having a tensile strength at break of 24.5 MPa and an elongation at break of 20.2%

### EMBODIMENT FOUR

Outer layers (A, C,) both contain linear high density polyethylene; 90% crystallinity. The thickness of the combined outer layers is 50% of the total thickness of the base film Inner layer (B) contains of 80% linear high density polyethylene and 20% cyclic olefin copolymers derived from C2-C10 linear olefin monomers and C5-C16 cyclic olefin monomers from the group: cyclopentene, cyclohexene, cycloheptene, dicyclopentadiene, tetracyclododecene, and methyl-tetracyclododecene. The thickness of this layer (B) is 50% of the total base film thickness. An adhesive layer was applied to this base film to afford a self-adhesive tape having a tensile strength at break of 35.5 MPa and an elongation at break of 55.2%

### EMBODIMENT FIVE

Outer layers (A, C,) both contain linear high density polyethylene; 90% crystallinity. The thickness of the combined outer layers is 50% of the total thickness of the base film Inner layer (B) contains 50% linear high density polyethylene and 50% cyclic olefin copolymers derived from C2-C10 linear olefin monomers and C5-C16 cyclic olefin onomers from the group: cyclopentene, cyclohexene, cycloheptene, dicyclopentadiene, tetracyclododecene, and methyl-tetracyclododecene. The thickness of this layer (B) is 50% of the total base film thickness. An adhesive layer was applied to this base film to afford a self-adhesive tape having a tensile strength at break of 30.5 MPa and an elongation at break of 45.2%

### EMBODIMENT SIX

Outer layers (A, C,) both contain linear high density polyethylene; 90% crystallinity. The thickness of the combined outer layers is 50% of the total thickness of the base film Inner layer (B) contains of 20% linear high density polyethylene and 80% cyclic olefin copolymers derived from C2-C10 linear olefin monomers and C5-C16 cyclic olefin monomers from the group: cyclopentene, cyclohexene, cycloheptene, dicyclopentadiene, tetracyclododecene, and methyl-tetracyclododecene. The thickness of this layer (B) is 50% of the total base film thickness. An adhesive layer was applied to this base film to afford a self-adhesive tape having a tensile strength at break of 28.5 MPa and an elongation at break of 40.2%

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents.

We claim:

1. A self-adhesive tape comprising a multilayer structure comprising:
A) a first outer layer, said first outer layer comprising liner polyolefins;
B) a second outer layer, said second outer layer comprising linear polyolefins;
C) an inner layer positioned between said first outer layer and said second outer layer, said inner layer comprising linear polyolefins and cyclic olefin copolymers; and
D) at least one adhesive layer on at least either said first outer layer or said second outer layer.

2. The self-adhesive tape of claim 1, wherein said linear olefins first outer layer and said second outer layer comprise ethylene repeat units.

3. The self-adhesive tape of claim 2, wherein said linear polyolefins have a crystallinity in the range of 40% to 100% derived from C₂-C₁₀ olefin monomers being at least 60% said ethylene repeat units.

4. The self-adhesive tape of claim 1, wherein said inner layer further comprises linear polyolefins having a crystallinity ranging from 40% to 100% derived from C2-C10 olefin monomers being at least 60% ethylene monomer repeat units.

5. The self-adhesive tape of claim 1, said inner layer polymers or copolymers being derived from cyclic C5-C16 olefins which cyclic olefin polymers or copolymers are amorphous or flow crystallinity and are selected from the group cyclopentene, cyclohexene, cycloheptene, dicyclopentadiene, tetracyclododecene, and methyl-tetracyclododecene.

6. The self-adhesive tape of claim 1, wherein said inner layer comprises a weight percent of linear polyolefins and cyclic polyolefins ranges from 10% to 90%.

7. The self-adhesive tape of claim 1, wherein said inner layer has a weight percent ratio of linear polyolefins to cyclic polyolefins ranges from 3:1 to 4:1.

8. The self-adhesive tape of claim 4, said cyclic olefins of said inner layer being copolymers comprising: C2-C10 olefins and C5-C16 cyclic olefin monomers.

9. The self-adhesive tape of claim 1, wherein said first outer layers and said second outer layer have modus of elasticicity lower than 350 MPa.

10. The self-adhesive tape of claim 1, and a modulus of elasticity for the inner layer of less than 1200 MPa.

11. The self-adhesive tape of claim 1, further comprising said adhesive on each of said outer layers.

12. The self-adhesive tape of claim 1, further comprising the colorants in at least one of the layers.
